(19) United States
(12) Patent Application Publication
(10) Pub. No.: US 2025/0110389 A1
(43) Pub. Date: Apr. 3, 2025

(54) VOICE COIL MOTOR, CAMERA MODULE, AND ELECTRONIC DEVICE

(71) Applicant: GUANGDONG OPPO MOBILE TELECOMMUNICATIONS CORP., LTD., Dongguan (CN)

(72) Inventors: Zhi WANG, Dongguan (CN); Song Yang, Dongguan (CN); Mozhou Lin, Dongguan (CN)

(73) Assignee: GUANGDONG OPPO MOBILE TELECOMMUNICATIONS CORP., LTD., Dongguan (CN)

(21) Appl. No.: 18/979,064

(22) Filed: Dec. 12, 2024

Related U.S. Application Data
(63) Continuation of application No. PCT/CN2023/102568, filed on Jun. 27, 2023.

(30) Foreign Application Priority Data
Aug. 24, 2022 (CN) 202211021815.9

(51) Int. Cl. G03B 13/36; G03B 3/10; G03B 5/02

(52) U.S. Cl. CPC G03B 13/36; G03B 3/10; G03B 5/02; G03B 2205/0015; G03B 2205/0023; G03B 2205/0069

(57) ABSTRACT

A voice coil motor includes a housing, a focusing structure, and an anti-shake structure. The focusing structure is arranged on the housing and includes a first carrier and a first driving assembly. The anti-shake structure includes a second carrier and a second driving assembly. The second carrier is an integral structure accommodated in the first carrier and includes a first sub-section and a second sub-section, which are connected to each other. The first sub-section is configured to accommodate a lens. The second sub-section is configured to install a partial structure of the second driving assembly. A camera module and an electronic device are also provided.

### CROSS REFERENCE TO RELATED APPLICATIONS

The present disclosure is a continuation of International Patent Application No. PCT/CN2023/102568, filed Jun. 27, 2023, which claims priority to Chinese patent application No. 202211021815.9, filed Aug. 24, 2022, the entire contents of these applications are incorporated herein by reference.

### TECHNICAL FIELD

The present disclosure relates to the field of imaging technologies, and in particular to a voice coil motor, a camera module, and an electronic device.

### BACKGROUND

A camera module is a common component of an electronic device such as a mobile phone. Requirements for shooting functions of the camera module are becoming increasingly stringent. For example, the camera module is required to have an auto-focus function, and is also expected to have an anti-shake function, in order to capture high-quality images in different shooting scenarios.

### SUMMARY

A voice coil motor provided by the embodiments of the present disclosure includes a housing, a focusing structure, and an anti-shake structure. The focusing structure is arranged on the housing and includes a first carrier and a first driving assembly. The anti-shake structure includes a second carrier and a second driving assembly. The second carrier is an integral structure accommodated in the first carrier and includes a first sub-section and a second sub-section connected with each other. The first sub-section is configured to accommodate a lens. The second sub-section is configured to install a partial structure of the second driving assembly. The first driving assembly is configured to drive the first carrier to move along an optical axis of the lens for focusing. The second driving assembly is configured to drive the second carrier to move in a plane perpendicular to the optical axis or to rotate around the optical axis for anti-shaking

A camera module provided by the embodiments of the present disclosure includes a lens and the voice coil motor mentioned above. The lens is installed on the first sub-section.

An electronic device provided by the embodiments of the present disclosure includes a main body and the camera module mentioned above. The camera module is installed on the main body.

Additional aspects and advantages of the present disclosure are set forth in part in the following description, and part of which will become obvious from the following description or be learned through practice of the present disclosure.

### BRIEF DESCRIPTION OF THE DRAWINGS

The above and/or additional aspects and advantages of the present disclosure will become obvious and understandable from the description of the embodiments in conjunction with the accompanying drawings.

FIG. 1 is a schematic assembled view of a voice coil motor according to some embodiments of the present disclosure.

FIG. 2 is a schematic exploded view of a voice coil motor according to some embodiments of the present disclosure.

FIG. 3 is a schematic exploded view of a housing of a voice coil motor according to some embodiments of the present disclosure.

FIG. 4 is a schematic exploded view of a partial structure of a voice coil motor according to some embodiments of the present disclosure.

FIG. 5 is a schematic exploded view of a partial structure of a voice coil motor according to some embodiments of the present disclosure.

FIG. 6 is a schematic cross-sectional view along a line VI-VI of the voice coil motor shown in FIG. 1 according to some embodiments of the present disclosure.

FIG. 7 is a schematic structure view of a camera module according to some embodiments of the present disclosure.

FIG. 8 is a schematic structure view of an electronic device according to some embodiments of the present disclosure.

### DETAILED DESCRIPTION

The embodiments of the present disclosure are further described below in conjunction with the accompanying drawings. The same or similar labels in the drawings represent the same or similar elements or elements having the same or similar functions throughout.

In addition, the embodiments of the present disclosure described below in conjunction with the accompanying drawings are exemplary and are merely configured to explain the embodiments of the present disclosure, and should not be construed as limiting the present disclosure.

In the present disclosure, unless otherwise clearly specified and limited, a first feature being “on” or “under” a second feature may mean that the first feature is directly in contact with the second feature, or the first feature is indirectly in contact with the second feature via a middle medium. Moreover, a first feature being “on”, “above”, or “over” a second feature may mean that the first feature is exactly above or obliquely above the second feature, or simply means that a horizontal height of the first feature is higher than a horizontal height of the second feature. A first feature being “under”, “below”, or “beneath” a second feature may mean that the first feature is exactly below or obliquely below the second feature, or simply means that a horizontal height of the first feature is lower than a horizontal height of the second feature.

The following disclosure provides many different embodiments or examples for implementing different structures of the embodiments of the present disclosure. In order to simplify the disclosure of the embodiments of the present disclosure, components and arrangements of specific examples are described below. Of course, the specific examples are merely examples and are not intended to limit the present disclosure. Reference numerals and/or reference letters may be repeated in different examples in embodiments of the present disclosure for simplicity and clarity purpose, and it does not indicate a relationship between the various embodiments and/or arrangements discussed. The embodiments of the present disclosure provide examples of various specific processes and materials, and those of ordinary skill in the art may be aware of application of other processes and/or the use of other materials.

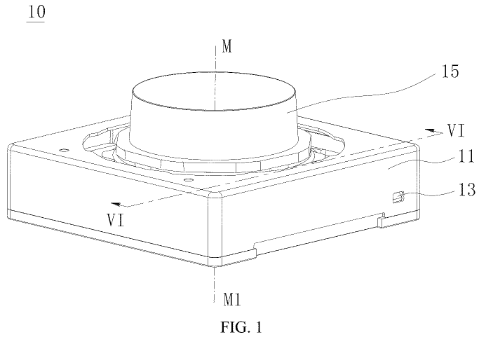

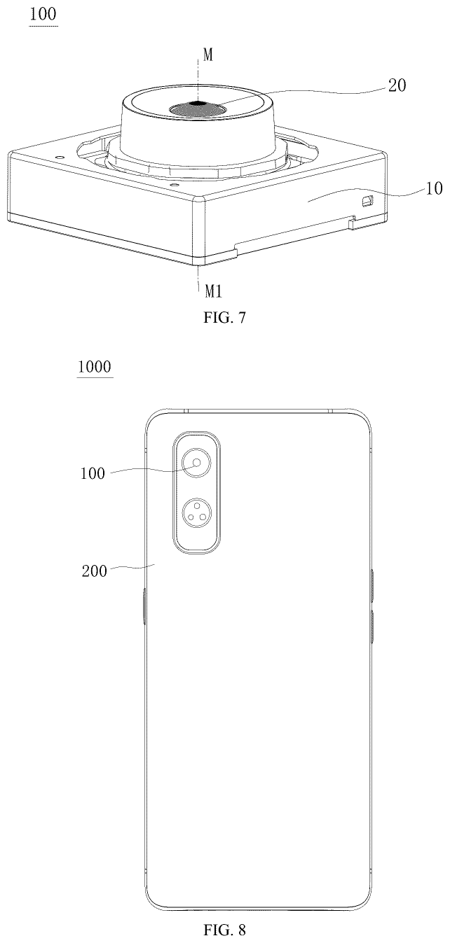

A camera module is a common component of an electronic device such as a mobile phone. Requirements for shooting functions of the camera module are becoming increasingly stringent. For example, the camera module is required to have an auto-focus function, and is also expected to have an anti-shake function, in order to capture high-quality images in different shooting scenarios. However, in order to realize the auto-focus function and the anti-shake function, the camera module is usually configured with multiple structure members, resulting in a relatively large size of the camera module, leading the camera module impossible to be miniaturized. Therefore, in order to solve the problems, embodiments of the present disclosure provide a voice coil motor 10 (shown in FIG. 1), a camera module 100 (shown in FIG. 7), and an electronic device 1000 (shown in FIG. 8).

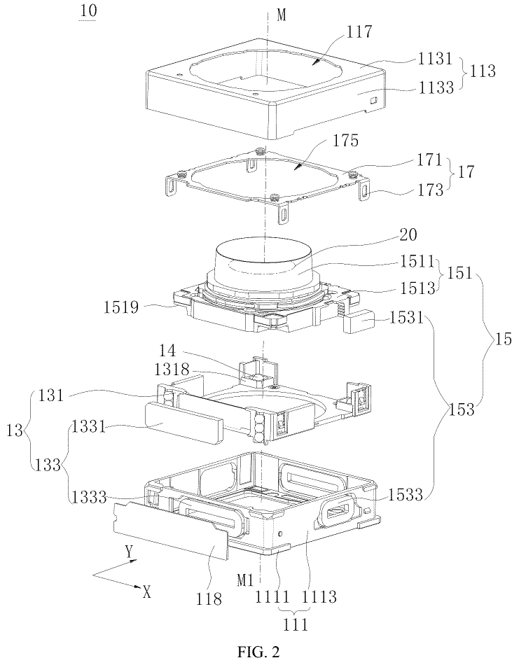

As shown in FIG. 1 and FIG. 2, the voice coil motor 10 in the embodiments of the present disclosure includes a housing 11, a focusing structure 13, and an anti-shake structure 15. The focusing structure 13 is arranged on the housing 11. The focusing structure 13 includes a first carrier 131 and a first driving assembly 133. The anti-shake structure 15 includes a second carrier 151 and a second driving assembly 153. The second carrier 151 is an integral structure accommodated in the first carrier 131. The second carrier 151 includes a first sub-section 1511 and a second sub-section 1513, which are connected to each other. The first sub-section 1511 is configured to accommodate a lens 20. The second sub-section 1513 is configured to install a partial structure of the second driving assembly 153. The first driving assembly 133 is configured to drive the first carrier 131 to move along an optical axis MM1 of the lens 20 for focusing. The second driving assembly 153 is configured to drive the second carrier 151 to move in a plane perpendicular to the optical axis MM1 or to rotate around the optical axis MM1 for anti-shaking.

The voice coil motor 10 in the embodiments of the present disclosure, by arranging the first driving assembly 133 to drive the first carrier 131 to move along the optical axis MM1 of the lens 20 for focusing, and arranging the second driving assembly 153 to drive the second carrier 151 to move in the plane perpendicular to the optical axis MM1 or to rotate around the optical axis MM1 for anti-shaking, has both focusing function and anti-shaking function. The second carrier 151 of the anti-shake structure 15 may not only install the lens 20, but also install the partial structure of the second driving assembly 153. In this way, it is not necessary to arrange two loading members, thereby saving structure members inside the camera module 100 (shown in FIG. 7) and the electronic device 1000 (shown in FIG. 8), and achieving miniaturization of the camera module 100 and the electronic device 1000.

The voice coil motor 10 are further described below in conjunction with the accompanying drawings.

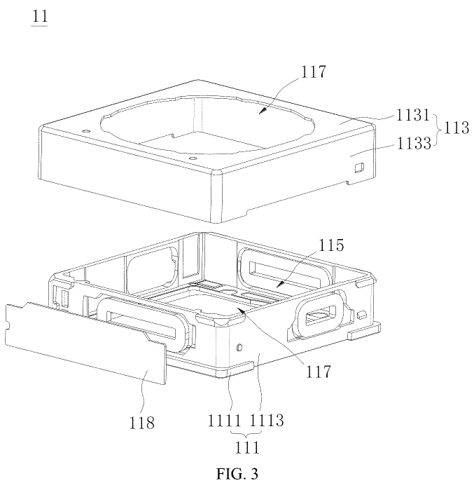

As shown in FIG. 3, in some embodiments, the housing 11 includes a base 111 and an outer housing 113. The outer housing 113 is installed on the base 111 and covers the base 111. The base 111 includes a bottom wall 1111 and a side wall 1113 extending from an edge (or a periphery) of the bottom wall 1111 toward the housing 113. The housing 113 includes a top plate 1131 matching a shape of the base 111 and a side plate 1133 extending from an edge (or a periphery) of the top plate 1131 toward the base 111. The housing 113 is connected to the base 111, and forms an accommodating space 115 together with the base 111. As shown in FIG. 2, both the focusing structure 13 and the anti-shake structure 15 are arranged on the housing 11. The second carrier 151 of the anti-shake structure 15 is accommodated in the focusing structure 13.

In some embodiments, the housing 113 may be non-detachably connected to the base 111 by means of welding and/or gluing. In some embodiments, the housing 113 may be detachably connected to the base 111 by means of threaded connecting, buckle connecting, hinge connecting, etc., which is not limited here. In the embodiments of the present disclosure, the housing 113 is connected to the base 111 by means of buckle connecting. For example, the side plate 1133 of the housing 113 is arranged with a coupling element (not shown), and the side wall 1113 of the base 111 is arranged with a connecting element (not shown). The coupling element and the connecting element cooperate to make the housing 113 to be installed on the base 111 and to cover the base 111. In some embodiments, there may be multiple coupling elements. The multiple coupling elements are arranged on one or more side plates 1133 of the housing 113. There may be multiple connecting elements. The multiple connecting elements are arranged on one or more side walls 1113 of the base 111. A quantitative relationship of the coupling elements and the connecting elements may be one-to-one or many-to-one. For example, one coupling element corresponds to one connecting element, multiple coupling elements correspond to one connecting element, or multiple coupling elements correspond to multiple connecting elements.

As shown in FIG. 3, in some embodiments, the housing 11 is defined with a light-through hole 117 that allows external light to pass through. Both the bottom wall 1111 of the base 111 and the top plate 1131 of the housing 113 are defined with the light-through hole 117. The light-through hole 117 may be in any shape such as a square, a circle, a triangle, etc. In some embodiments, a shape of the housing 11 may be a cube, a cuboid, a triangular prism, a hexagonal prism, etc., which is not limited here. That is, both a shape of the housing 113 and a shape of the base 111 may also be cubes, cuboids, triangular prisms, hexagonal prisms, and other shapes.

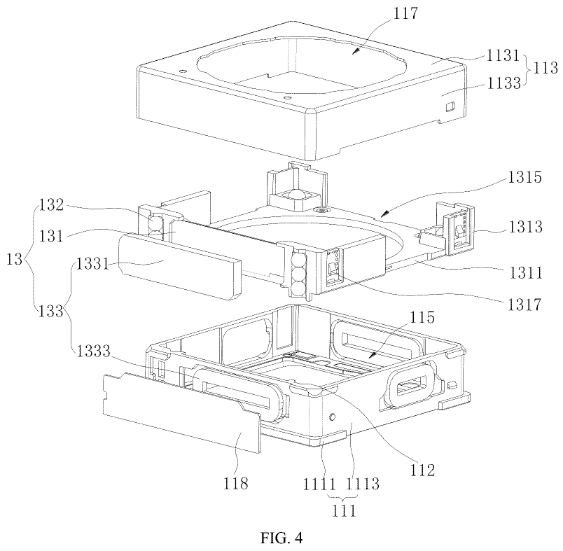

As shown in FIG. 2 and FIG. 4, in some embodiments, the focusing structure 13 includes the first carrier 131 and the first driving assembly 133. The partial structure of the focus structure 13 is accommodated in the accommodating space 115 of the housing 11. One of the first carrier 131 and the first driving assembly 133 is arranged in the housing 11, and another one of the first carrier 131 and the first driving assembly 133 is arranged on the housing 11. The first driving assembly 133 is configured to drive the first carrier 131 to move along the optical axis MM1 of the lens 20 for focusing.

As shown in FIG. 2 and FIG. 4, in some embodiments, the first carrier 131 includes a bottom wall 1311 and a side wall 1313 extending from the bottom wall 1311 toward the housing 113. The bottom wall 1311 of the first carrier 131 and the side wall 1313 of the first carrier 131 together form a cavity 1315. An outer side of the side wall 1313 of the first carrier 131 is arranged with a matching element 132. An inner side of the side wall 1113 of the base 111 is arranged with a guiding element 112. The guiding element 112 cooperates with the matching element 132 to guide the first carrier 131 to move along the optical axis MM1 of the lens 20. In the embodiments of the present disclosure, a number of the guiding element 112 is two and a number of the matching element 132 is two. Two guiding elements 112 and two matching elements 132 form two guiding groups. The two guiding groups are capable of limiting the first carrier 131 to deflect and/or flip when moving along the optical axis MM1 during a focusing process. The first carrier 131 deflecting refers to the first carrier 131 rotating around the optical axis MM1 in a plane perpendicular to the optical axis MM1. The first carrier 131 flipping refers to the first carrier 131 rotating around an X-axis or a Y-axis of the plane (perpendicular to the optical axis MM1). In some embodiments, the guiding element 112 may be a guiding rail and the matching element 132 may be a guiding ball. That is, the outer side of the side wall 1313 of the first carrier 131 is arranged with a guiding ball, and the inner side of the side wall 1113 of the base 111 is arranged with a guiding rail. The guiding rail cooperates with the guiding ball to limit rotation (including deflecting and/or flipping mentioned above) during the focusing process where the first carrier 131 moves along the optical axis MM1, thereby improving imaging quality. Alternatively, the outer side of the side wall 1313 of the first carrier 131 is arranged with a guiding rail, and the inner side of the side wall 1113 of the base 111 is arranged with a guiding ball. In some embodiments, a number of the guiding ball may be one or more. In the embodiments of the present disclosure, each guiding rail may be arranged with multiple guiding balls. The multiple guiding balls make a contact surface of the guiding balls and the guiding rail of the guiding group larger, and fulcrums more stable. Compared with a situation where only one guiding ball is arranged in each guiding rail, guiding effect is more stable. A degree of shaking of the first carrier 131 during moving along the optical axis MM1 of the lens 20 is greatly reduced, thereby avoiding the problem of movement jamming caused by large degree of shaking, and ensuring that the focusing function performs in a normal manner.

In some embodiments, the guiding element 112 may be a guiding rod and the matching element 132 may be a guiding rail. That is, the outer side of the side wall 1313 of the first carrier 131 is arranged with a guiding rail, and the inner side of the side wall 1113 of the base 111 is arranged with a guiding rod. The guiding rail cooperates with the guiding rod to limit rotation (including deflecting and/or flipping mentioned above) during the focusing process where the first carrier 131 moves along the optical axis MM1, thereby improving imaging quality. Alternatively, the outer side of the side wall 1313 of the first carrier 131 is arranged with a guiding rod, and the inner side of the side wall 1113 of the base 111 is arranged with a guiding rail.

As shown in FIG. 4, in some embodiments, the first driving assembly 133 includes a first magnet 1331 and a first coil 1333 arranged opposite to the first magnet 1331. One of the first magnet 1331 and the first coil 1333 is arranged on the side wall 1113 of the base 111. Another one of the first magnet 1331 and the first coil 1333 is arranged on the side wall 1313 of the first carrier 131. The first coil 1333 is capable of generating a first driving force with the first magnet 1331 when powered on. The first driving force is configured to drive the first carrier 131 to move along the optical axis MM1 (shown in FIG. 2) for focusing.

In some embodiments, the first magnet 1331 may be a permanent magnet (with a magnetic field), such as a neodymium-iron-boron (NdFeB) magnet, a ferrite magnet, an aluminum-nickel-cobalt (AlNiCo) magnet, or the like, which is not limited herein. When the first coil 1333 is power-on, the first coil 1333 is capable of generating a magnetic field, so that the first driving force may be generated between the first magnet 1331 and the first coil 1333. The first driving force drives the first carrier 131 to move along the optical axis MM1 to achieve the focusing function.

In some embodiments, the first magnet 1331 may be arranged on one of the side wall 1113 of the base 111 and the side wall 1313 of the first carrier 131 by means of embedding, bonding, buckling, etc. The first coil 1333 may be directly arranged on another one of the side wall 1113 of the base 111 and the side wall 1313 of the first carrier 131 by means of embedding, bonding, buckling, threaded connecting, welding, etc. The first coil 1333 is electrically connected to a circuit board 118 through a conductive member (not shown). The first coil 1333 may also be formed on the circuit board 118 to be electrically connected to the circuit board 118. The circuit board 118 is arranged on the another one of the side wall 1113 of the base 111 and the side wall 1313 of the first carrier 131 by means of embedding, bonding, buckling, threaded connecting, welding, etc. In addition, the first magnet 1331 is arranged opposite to and separated from the first coil 1333. In this way, collision or friction between the first magnet 1331 and the first coil 1333 when the first carrier 131 moves along the optical axis MM1 is avoided, which may lead to damage to the first magnet 1331 and/or the first coil 1333, and further affect the voice coil motor 10 (shown in FIG. 2) performing in a normal manner.

In some embodiments, a number of the first magnet 1331 may be one, and a number of the first coil 1333 may also be one. The first magnet 1331 corresponds to the first coil 1333. In some embodiments, there may be multiple first magnets 1331 and multiple first coils 1333. The first magnets 1331 and the first coils 1333 may be one-to-one or many-to-one. For example, one of the first magnets 1331 corresponds to one of the first coils 1333, or multiple of the first magnets 1331 correspond to one of the first coils 1333.

In some embodiments, magnitude and direction of the magnetic field generated by the first coil 1333 may be adjusted according to magnitude and direction of a current passing through the first coil 1333. The first magnet 1331 cooperates with a power-on first coil 1333 to generate the first driving force. The voice coil motor 10 may adjust the magnitude and direction of the current passing through the first coil 1333 to adjust distance and direction of a movement of the first carrier 131 along the optical axis MM1. Directions of the optical axis MM1 include a positive direction of the optical axis MM1 and an opposite direction of the optical axis MM1. The positive direction of the optical axis MM1 is a direction from the base 111 to the housing 113. The opposite direction of the optical axis MM1 is a direction from the housing 113 to the base 111. The voice coil motor 10 is capable of changing the direction of the current passing through the first coil 1333, enabling the first driving force generated between the first magnet 1331 and the first coil 1333 to drive the first carrier 131 to move along the positive direction of the optical axis MM1 or along the opposite direction of the optical axis MM1. The voice coil motor 10 is also capable of controlling the distance that the first carrier 131 is driven to move along the positive direction of the optical axis MM1 or along the opposite direction of the optical axis MM1 by changing the magnitude of the current passing through the first coil 1333.

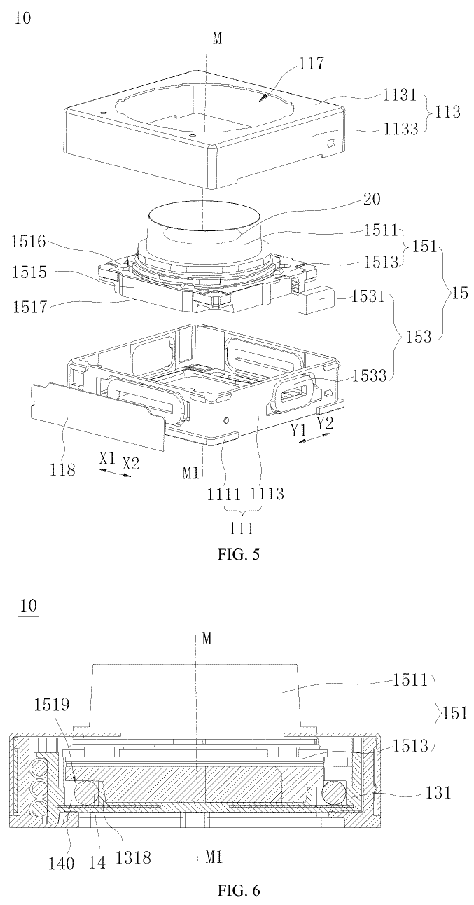

As shown in FIG. 2 and FIG. 5, in some embodiments, the anti-shake structure 15 includes the second carrier 151 and the second driving assembly 153. The second driving assembly 153 is configured to drive the second carrier 151 to move in the plane perpendicular to the optical axis MM1 or to rotate around the optical axis MM1 to realize the anti-shake function.

In some embodiments, when the camera module 100 is working, for example, when the focusing structure 13 starts to work (representing that the camera module 100 is working), the second driving assembly 153 is capable of driving the second carrier 151 to move within the plane perpendicular to the optical axis MM1 of the lens 20 and/or to rotate (or deflect mentioned above) around the optical axis MM1 of the lens 20 within a plane of the optical axis MM1. In this way, a jitter (offset) generating by the lens 20 along the X-axis direction or the Y-axis direction of the plane perpendicular to the optical axis MM1 and a jitter generating by the lens 20 around the optical axis MM1 within an XY plane during the focusing process may be counteracted, thereby achieving the anti-shake function. Since the first driving assembly 133 is capable of driving the first carrier 131 of the focusing structure 13 to move along the optical axis MM1 of the lens 20 to realize the focusing function, and the second driving assembly 153 is capable of driving the second carrier 151 to move within the plane perpendicular to the optical axis MM1 and/or to rotate around the optical axis MM1 to realize the anti-shake function, the camera module 100 (shown in FIG. 7) is able to realize both the focusing function and the anti-shake function, thereby improving shooting effect.

As shown in FIG. 4, in some embodiments, the second carrier 151 is arranged in the cavity 1315. The second carrier 151 is arranged at a bottom of the cavity 1315 of the first carrier 131 via a plurality of guiding members 14. The second carrier 151 is able to move in the plane perpendicular to the optical axis MM1 and/or to perform axial rotation around the optical axis MM1 within the plane. In this way, the jitter generating by the lens 20 along the X-axis direction or the Y-axis direction of the plane perpendicular to the optical axis MM1 during the focusing process may be counteracted, thereby realizing the anti-shake function.

As shown in FIG. 2 and FIG. 4, in some embodiments, a plurality of guiding blocks 1318 protrude from the bottom of the cavity 1315 and extend along a direction toward the second carrier 151. The bottom 1517 of the second carrier 151 is depressed to form a plurality of guiding grooves 1519. The plurality of guiding grooves 1519 correspond to the plurality of guiding blocks 1318. As shown in FIG. 6, each of the guiding blocks 1318 extends into a corresponding guiding groove 1519, and forms a guiding cavity 140. Each guiding cavity 140 is accommodating with one of the guiding members 14. Each of the guiding members 14 is in contact with a bottom surface of the corresponding guiding groove 1519, and is able to move in a corresponding guiding cavity 140. A side wall of the guiding cavity 140 is configured to define a movement stroke of a corresponding guiding member 14.

As shown in FIG. 2 and FIG. 5, in some embodiments, the second carrier 151 includes the bottom 1517. A plurality of guiding blocks 1318 protrude from the bottom wall 1311 of the first carrier 131 and extend along a direction toward the second carrier 151. The bottom 1517 of the second carrier 151 is recessed along a direction away from the first carrier 131 to form a plurality of guiding grooves 1519. The plurality of guiding grooves 1519 correspond to the plurality of guiding blocks 1318. Each of the guiding blocks 1318 extends into a corresponding guiding groove 1519 and form a guiding cavity 140. Each guiding cavity 140 is accommodating with a corresponding guiding member 14. The guiding member 14 is able to in contact with both a bottom of the guiding cavity 140 and a bottom surface of the guiding groove 1519, and is able to move freely in the guiding cavity 140. In this way, the second sub-section 1513 of the second carrier 151 is able to be carried on the bottom of the cavity 1315 of the first carrier 131, and the second sub-section 1513 is capable of moving on the bottom wall 1311 of the first carrier 131, i.e., in the plane perpendicular to the optical axis MM1 (including moving in the X-direction and the Y-direction) and/or rotating around the optical axis MM1 in the plane. Therefore, the jitter generating by the lens 20 along the X-axis direction or the Y-axis direction of the plane during the focusing process may be counteracted, thereby realizing the anti-shake function.

As shown in FIG. 6, in some embodiments, each of the guiding blocks 1318 may extend into the corresponding guiding groove 1519. A side wall of the guiding block 1318 is in contact with a side wall of the corresponding guiding groove 1519. In this way, a movement stroke of the second carrier 151 is limited, thereby avoiding the problems such as failure of the anti-shake function and derailment of the second carrier 151 (separating from the first carrier 131) caused by an excessive movement stroke of the second carrier 151.

As shown in FIG. 2, FIG. 4, and FIG. 5, in some embodiments, the guiding member 14 accommodated in the guiding cavity 140 may be an anti-shake ball. The anti-shake ball is able to roll in the guiding cavity 140, making the second carrier 151 to be able to move in the plane perpendicular to the optical axis MM1 of the lens 20 (including moving in the X-direction and the Y direction, the same hereinafter) and/or to rotate around the optical axis MM1 within the plane. In some embodiments, both a depth of the guiding cavity 140 along a direction of the optical axis MM1 and a depth of the guiding groove 1519 along the direction of the optical axis MM1 are smaller than a diameter of the guiding member 14. In this way, the guiding member 14 is able to be in contact with both the bottom wall of the guiding cavity 140 and the bottom wall of the guiding groove 1519. In the embodiments of the present disclosure, both a number of the guiding blocks 1318 and a number of the guiding grooves 1519 are four. A number of the guiding members 14 in the guiding blocks 1318 is also four. The four guiding blocks 1318 are respectively arranged at four corners of the first carrier 131 and the four guiding grooves 1519 are respectively arranged at four corners of the second carrier 151, ensuring that the second carrier 151 may move stably. In some embodiments, a quantity and position of the guiding blocks 1318 and a quantity and position of the guiding grooves 1519 may be set according to specific requirements. For example, in the case that both a cross-sectional shape of the first carrier 131 and a cross-sectional shape of the second carrier 151 along the plane perpendicular to the optical axis MM1 are hexagonal, both the number of the guiding blocks 1318 and the number of the guiding grooves 1519 may be six. That is, the six guiding blocks 1318 are respectively arranged at six corners of the first carrier 131 and the six guiding grooves 1519 are respectively arranged at six corners of the second carrier 151. In some embodiments, the guiding blocks 1318 and the guiding grooves 1519 may not be arranged at the corners. For example, the guiding blocks 1318 may be arranged on the side wall 1313 of the first carrier 131 and the guiding grooves 1519 may be arranged on the side wall 1515 of the second sub-section 1513 of the second carrier 151, ensuring that the second carrier 151 may move more stably.

In some embodiments, a plurality of guiding blocks protrude from the bottom 1517 of the second carrier 151 and extend along a direction toward the first carrier 131. The bottom of the cavity 1315 is recessed to form a plurality of guiding grooves. The plurality of guiding grooves correspond to the plurality of guiding blocks. Each of the guiding blocks extends into a corresponding guiding groove and forms a guiding cavity. Each guiding cavity is accommodating with a corresponding guiding member. The guiding member is in contact with a bottom surface of the corresponding guiding groove and is able to move in the guiding cavity. A side wall of the guiding cavity is configured to limit a movement stroke of the corresponding guiding member.

As shown in FIG. 5 and FIG. 6, in some embodiments, the second carrier 151 is an integrally injection-molded member.

In some embodiments, the second carrier 151 includes the first sub-section 1511 and the second sub-section 1513, which are connected to each other. The first sub-section 1511 is configured for accommodating the lens 20. The second sub-section 1513 is configured for installing the partial structure of the second driving assembly 153. By accommodating the lens 20 and installing the partial structure of the second driving assembly 153 via the second carrier 151 with an integrated structure, the voice coil motor 100 is able to avoid the problem that the camera module 100 (shown in FIG. 7) and the electronic device 1000 (shown in FIG. 8) having too many internal structure members because of arranging multiple loading members, thereby realizing the miniaturization of the voice coil motor 10, the camera module 100 (shown in FIG. 7), and the electronic device 1000 (shown in FIG. 8). In addition, the second carrier 151 has an integrated structure, which may reduce the assembly process of the voice coil motor 10 and improve production efficiency. The lens 20 and the second carrier 151 may be formed integrally. For example, the lens 20 and the second carrier 151 are integrally formed through a two-color injection molding process. A material of the lens 20 is different from a material of the second carrier 151. The lens 20 is made of white material, and the second carrier 151 is made of black material. In some embodiments, the lens 20 may be made of resin with a relatively high light transmittance, and the second carrier 151 is made of resin with a relatively low light transmittance to prevent light leakage. Alternatively, the second carrier 151 is made of resin with a low light transmittance, and is painted with black paint to achieve effect of preventing light leakage. The lens 20 and the second carrier 151 are integrally formed, which may simplify the assembly process and improve the production efficiency.

In related art, a voice coil motor is usually arranged with a structure member for installing a lens and a structure member for installing a second driving assembly, and two structure members are combined together. In some embodiments of the present disclosure, the second carrier 151 is an integrally injection-molded member. The second carrier 151 after molding is more stable than a combined structure of the two structure members, preventing damage during operation of the anti-shake structure 15 and thus avoiding affecting the voice coil motor 10 performing in a normal manner. In addition, the second carrier 151 is an integrally injection-molded member, which may also enhance dustproof and waterproof effects of the second carrier 151, preventing external impurities such as water and dust from entering interior of the second carrier 151, which would otherwise cause the lens 20 and other structures inside the second carrier 151 to be contaminated and affect the imaging effect of the camera module 100 (shown in FIG. 7).

In some embodiments, the second carrier 151 may be made of thermoplastics plastics, such as polyethylene, polypropylene, polyvinyl chloride, polystyrene, etc. The second carrier 151 may also be made of thermosetting plastics, such as phenolic resin, urea-formaldehyde resin, etc. Using plastic materials may reduce an overall weight of the second carrier 151, reduce power consumption of the voice coil motor 10, and reduce production costs. In the embodiments of the present disclosure, the material of the second carrier 151 is thermoplastic plastic. The first sub-section 1511 and the second sub-section 1513 may be integrally injection-molded by using a same type of thermoplastic plastic. Alternatively, the first sub-section 1511 and the second sub-section 1513 may be integrally injection-molded by using different thermoplastic plastics, for example, through a two-color molding process. In some embodiments, the second carrier 151 may also be made of metal materials, such as aluminum alloy, etc. Using metal materials may enhance supportability and stability of the second carrier 151, preventing normal performance of the voice coil motor 10 from being affected due to damage to the second carrier 151.

As shown in FIG. 5, in some embodiments, the second driving assembly 153 includes a second magnet 1531 and a second coil 1533 arranged opposite to the second magnet 1531. One of the second magnet 1531 and the second coil 1533 is arranged on the side wall 1113 of the base 111, and another one of the second magnet 1531 and the second coil 1533 is arranged on the side wall 1515 of the second sub-section 1513 of the second carrier 151. The second coil 1533 is capable of generating a second driving force with the second magnet 1531 when powered on. The second driving force is configured to drive the second carrier 151 to move in the plane perpendicular to the optical axis MM1 of the lens 20 and/or to rotate around the optical axis MM1 of the lens 20 within the plane. A jitter generating by the lens 20 along the X-axis direction or the Y-axis direction of the plane perpendicular to the optical axis MM1 or a jitter generating by the lens 20 around the optical axis MM1 may be counteracted, thereby realizing the anti-shake function.

In some embodiments, as shown in FIG. 2, the second magnet 1531 may be arranged on one of the side wall 1113 of the base 111 and the side wall 1515 of the second sub-section 1513 by means of embedding, bonding, buckling, etc. The second coil 1533 may be directly arranged on another one of the side wall 1113 of the base 111 and the side wall 1515 of the second sub-section 1513 by means of embedding, bonding, buckling, threaded connecting, welding, etc. The second coil 1513 is electrically connected to a circuit board (not shown) through a conductive member. The second coil 1533 may also be formed on the circuit board to be electrically connected to the circuit board. The circuit board is arranged on the another one of the side wall 1113 of the base 111 and the side wall 1515 of the second sub-section 1513 by means of embedding, bonding, buckling, threaded connecting, welding, etc. The second magnet 1531 is arranged opposite to and separated from the second coil 1533. In this way, collision or friction between the second magnet 1531 and the second coil 1533 when the first carrier 131 moves along the optical axis MM1 is avoided, which may lead to damage to the second magnet 1531 and/or the second coil 1533 and further affect the voice coil motor 10 performing in a normal manner.

In some embodiments, in the case that the second magnet 1531 or the second coil 1533 is arranged on the side wall 1515 of the second sub-section 1513 by means of embedding, the second carrier 151 and the second magnet 1531 or the second coil 1533 may be formed into an integral structure through two injection molding processes. Firstly, a basic structure of the second carrier 151 (the integrally injection-molded member mentioned above) is formed by means of injection molding. The basic structure is defined with an accommodating space (not shown) on the side wall 1113 of the base 111 corresponding to the second magnet 1531 or the second coil 1533. Next, the second magnet 1531 or the second coil 1533 is arranged in the accommodating space. Then, a second injection molding is performed on the basic structure and the second magnet 1531, or the basic structure and the second coil 1533, using a material the same as a material of the basic structure, in order to completely wrap the second magnet 1531 or the second coil 1533. In this way, the second magnet 1531 or the second coil 1533 is embedded in the side wall 1515 of the second sub-section 1513. In some embodiments, the second magnet 1531 or the second coil 1533 may be installed in the accommodating space through surface mounted technology (SMT) patching process.

In some embodiments, the second magnet 1531 may be a permanent magnet (with a magnetic field), such as a neodymium-iron-boron (NdFeB) magnet, a ferrite magnet, an aluminum-nickel-cobalt (AlNiCo) magnet, etc., which is not limited here. When the second coil 1533 is power-on, the second coil 1533 is able to generate a magnetic field, so that the second driving force may be generated between the second magnet 1531 and the second coil 1533. The second driving force drives the second carrier 151 to move within the plane perpendicular the optical axis MM1 of the lens 20 and/or to rotate around the optical axis MM1 of the lens 20 within the plane, so as to realize the anti-shake function.

As shown in FIG. 5, in some embodiments, there are a plurality of second magnets 1531. The plurality of second magnets 1531 respectively arranged along the X-axis direction and the Y-axis direction of the plane perpendicular to the optical axis MM1. That is, the plurality of second magnets 1531 are respectively arranged on one of the side wall 1113 of the base 111 and the side wall 1515 of the second sub-section 1513 along the X-axis direction and the Y-axis direction. There are a plurality of second coils 1533. The plurality of second coils 1533 are respectively arranged on another one of the side wall 1113 of the base 111 and the side wall 1515 of the second sub-section 1513 along the X-axis direction and the Y-axis direction. A quantitative relationship of the second magnets 1531 and the second coils 1533 may be one-to-one or many-to-one. For example, one of the second magnets 1531 corresponds to one of the second coils 1533, or multiple second magnets 1531 correspond to one of the second coils 1533.

In some embodiments, magnitude and direction of the magnetic field generated by the second coil 1533 may be adjusted according to magnitude and direction of a current passing through the second coil 1533. The second magnet 1531 cooperates with a power-on second coil 1533 to generate the second driving force. The voice coil motor 10 may adjust magnitude and direction of the current passing through the second coil 1533 to adjust distance and direction of a movement of the second carrier 151 along the X-axis direction and the Y-axis direction, as well as angle and direction of rotation of the second carrier 151 around the optical axis MM1 in the XY plane.

As shown in FIG. 2, in some embodiments, the voice coil motor 10 further includes a fixing structure 17. The fixing structure 17 is installed on the first carrier 131 and is configured to limit the second carrier 151 so that the second carrier 151 moves with the first carrier 131 along the optical axis MM1 towards an object side of the lens 20.

In some embodiments, the fixing structure 17 is arranged in the accommodating space 115 (shown in FIG. 3) of the housing 11. The fixing structure 17 is detachably connected to the first carrier 131, avoiding movement of the second carrier 151 along the optical axis MM1 toward the object side of the lens 20 relative to the first carrier 131 causing deviation from a position with clear focusing during performing jitter compensation for movement of the second carrier 151 within the XY plane or rotation around the optical axis MM1 within the XY plane, thereby ensuring a better imaging effect of the camera module 100 (shown in FIG. 7).

As shown in FIG. 2, FIG. 4, and FIG. 5, in some embodiments, the fixing structure 17 includes a blocking member 171 and a plurality of connecting members 173 extending from an edge (or periphery) of the blocking member 171 and along the direction toward the first carrier 131. The blocking member 171 is arranged on the top wall 1516 of the second sub-section 1513. The outer side of the side wall 1313 of the first carrier 131 is arranged with a plurality of coupling members 1317. Each of the connecting members 173 is connected to a corresponding coupling member 1317, so as to limit the second carrier 151 to move along the optical axis MM1 toward the object side of lens 20 relative to the first carrier 131. In some embodiments, there may be multiple coupling members 1317. The multiple coupling members 1317 are arranged on the outer side of one or more side walls 1313 of the first carrier 131. there may be multiple connecting members 173. The multiple connecting members 173 are arranged on the edge (or the periphery) of the blocking member 171. A quantitative relationship of the coupling members 1317 and the connecting members 173 may be one-to-one or many-to-one. For example, one of the coupling members 1317 corresponds to one of the connecting members 173, multiple coupling members 1317 correspond to one of the connecting members 173, or multiple coupling members 1317 correspond to multiple connecting members 173.

As shown in FIG. 2, in some embodiments, the blocking member 171 is defined with a through hole 175 corresponding to the lens 20 of the second carrier 151, enabling the first sub-section 1511 of the second carrier 151 to pass through the blocking member 175 through the through hole 175. In this way, external light is able to enter the lens 20 of the first sub-section 1511 by passing through the light-through hole 117 and the through hole 175 in sequence.

As shown in FIG. 7, the embodiments of the present disclosure also provide a camera module 100. The camera module 100 may include the voice coil motor 10 according to any one of the embodiments mentioned above and a lens 20. The lens 20 is installed on the first sub-section 1511.

As shown in FIG. 3, in some embodiments, the number of the lens 20 may be one or more. One or more lenses 20 are all arranged on the first sub-section 1511. Multiple lenses 20 may correct and filter the external light incident on the multiple lenses 20 from each other. When the external light passes through the lenses 20, the multiple lenses 20 filter stray light (such as infrared light) layer by layer to improve the imaging effect of the camera module 100. In some embodiments, the lens 20 may be a spherical lens, an aspherical lens, a free-form surface lens, etc., which is not limited here. A material of the lens 20 is plastic or glass, or a mixed material of plastic and glass, which is not limited here. The multiple lenses 20 may be fixedly arranged in the first sub-section 1511. The multiple lenses 20 may also move along the optical axis MM1 in the first sub-section 1511 (for example, an additional actuator is arranged to drive the lenses 20 to move), achieving zooming or precise focusing, thereby improving the imaging effect of the camera module 100.

As shown in FIG. 2 and FIG. 7, when assembling the camera module 100, firstly, one of the first coil 1333 and the first magnet 1331 is arranged on the first carrier 131, and another one of the first coil 1333 and the first magnet 1331 is arranged on the base 111. Then, the first carrier 131 loaded with the one of the first coil 1333 and the first magnet 1331 is arranged on the base 111 loaded with the another one of the first coil 1333 and the first magnet 1331. Next, one of the second coil 1533 and the second magnet 1531 is arranged on the second sub-section 1513, and another one of the second coil 1533 and the second magnet 1531 is arranged on the base 111. Then, the second carrier 151 installed with the second coil 1533 or the second magnet 1531 is arranged on the first carrier 131. The lens 20 may be integrally formed with the first sub-section 1511 of the second carrier 151. After that, the fixing structure 17 is installed on the first carrier 131 to limit the first carrier 131 to drive the second carrier 151 to move along the optical axis MM1 toward the object side of the lens 20. Finally, the housing 113 is covered on the base 111 to complete assembling.

When the camera module 100 performs focusing, the first coil 1333 of the first driving assembly 133 is power-on to generate the first driving force together with the first magnet 1331. The first driving force drives the first carrier 131 to move along the optical axis MM1 to drive the anti-shake structure 15 and the lens 20 arranged in the anti-shake structure 15 to move together along the optical axis MM1, thereby realizing the focusing function.

When the camera module 100 performs anti-shake, in the case that the lens 20 moves along the X-axis or the Y-axis or rotates around the optical axis MM1 within the XY plane, the second coil 1533 of the second driving assembly 153 may be power-on, enabling the second coil 1533 to interact with the second magnet 1531 to generate the second driving force. The second driving force drives the second carrier 151 to move along the X-axis or the Y-axis along an opposite direction or to rotate around the optical axis MM1 within the XY plane along an opposite direction, compensating a movement offset of the lens 20 moving along the X-axis or the Y-axis or a rotation offset of the lens 20 rotating around the optical axis MM1 within the XY plane, thereby realizing the anti-shake function. For example, in the case that the lens 20 moves 5 mm along a positive direction of the X-axis, the second coil 1533 of the second driving assembly 153 may be power-on, enabling the second coil 1533 to generate a magnetic field to interact with a magnetic field of the second magnet 1531, generating the second driving force. The second driving force drives the second carrier 151 to move 5 mm along an opposite direction of the X-axis, so as to compensate the movement offset of the lens 20 along the X-axis, and realize the anti-shake function.

As shown in FIG. 2 and FIG. 7, the camera module 100 in the embodiments of the present disclosure utilizes the first driving assembly 133 to drive the first carrier 131 to move along the optical axis MM1 of the lens 20 for focusing, and utilizes the second driving assembly 153 to drive the second carrier 151 to move in the plane perpendicular to the optical axis MM1 or to rotate around the optical axis MM1 for anti-shaking thereby having both the focusing function and the anti-shake function. The second carrier 151 of the anti-shake structure 15 may not only install the lens 20 but also install the partial structure of the second driving assembly 153, so that there is no need to arrange two loading members, which saves structure members inside the camera module 100 and realizes miniaturization of the camera module 100.

As shown in FIG. 8, in some embodiments of the present disclosure, an electronic device 1000 includes the camera module 100 according to any of the embodiments mentioned above and a main body 200. The camera module 100 is installed on the main body 200.

In some embodiments, the electronic device 1000 may be a mobile phone, a tablet computer, a camera, a personal digital assistant, a wearable device, a smart robot, a smart vehicle, etc. The wearable device includes a smart bracelet, a smart watch, smart glasses, etc. The camera module 100 may be installed on the main body 200, or installed in the main body 200, which is not limited here.

As shown in FIG. 2, the electronic device 1000 in the embodiments of the present disclosure utilizes the first driving assembly 133 to drive the first carrier 131 to move along the optical axis MM1 of the lens 20 for focusing, and utilizes the second driving assembly 153 to drive the second carrier 151 to move in the plane perpendicular to the optical axis MM1 or to rotate around the optical axis MM1 in the plane for anti-shaking thereby having both the focusing function and the anti-shake function. The second carrier 151 of the anti-shake structure 15 may not only install the lens 20 but also install the partial structure of the second driving assembly 153, so that there is no need to arrange two loading members, which saves structure members inside the camera module 100 and the electronic device 1000, and realizes miniaturization of the camera module 100 and the electronic device 1000.

In addition, in the voice coil motor 10, by arranging the guiding block 1318 at the bottom of the cavity 1315 or the bottom 1517 of the second carrier 151, and arranging the guiding groove 1519 at the bottom 1517 of the second carrier 151 or the bottom of the cavity 1315, the second carrier 151 is carried on the bottom of the cavity 1315, thereby reducing a height of the first carrier 131 and a height of the second carrier 151 in the direction of the optical axis MM1. In this way, the voice coil motor 10 is lighter and thinner, thereby further realizing the miniaturization of the camera module 100 and the electronic device 1000.

In the description of the specification, references of the terms “certain embodiments”, “one embodiment”, “some embodiments”, “exemplary embodiments”, “examples”, “specific examples”, or “some examples” mean that a specific feature, structure, material, or characteristic described in connection with the embodiments or examples is included in at least one embodiment or example of the present disclosure. In the specification, schematic representations of the above terms do not necessarily refer to the same embodiment or example. Furthermore, the described specific features, structures, materials, or characteristics may be combined in any suitable manner in any one or more embodiments or examples.

In addition, the terms “first” and “second” are used merely for descriptive purposes, and shall not be construed as indicating or implying relative importance or implicitly specifying a quantity of indicated technical features. Thus, features defined with “first” and “second” may explicitly or implicitly include at least one of the features. In the description of the present disclosure, the term “plurality” means at least two, such as two or three, unless otherwise specifically and clearly defined.

Although the embodiments of the present disclosure have been illustrated and described above, it should be understood that the above embodiments are exemplary and should not be construed as limitations on the present disclosure. Those skilled in the art may make changes, modifications, substitutions, and variations to the embodiments mentioned above within the scope of the present disclosure. The scope of the present disclosure is defined by the claims and equivalents thereof.

What is claimed is:

1. A voice coil motor, comprising:
a housing;
a focusing structure, arranged on the housing and comprising a first carrier and a first driving assembly; and
an anti-shake structure, comprising a second carrier and a second driving assembly, wherein the second carrier is an integral structure accommodated in the first carrier and comprises a first sub-section and a second sub-section connected with each other, the first sub-section is configured to accommodate a lens, and the second sub-section is configured to install a partial structure of the second driving assembly;
wherein the first driving assembly is configured to drive the first carrier to move along an optical axis of the lens for focusing, and the second driving assembly is configured to drive the second carrier to move in a plane perpendicular to the optical axis or to rotate around the optical axis for anti-shaking.

2. The voice coil motor according to claim 1, wherein the second carrier is an integrally injection-molded member.

3. The voice coil motor according to claim 1, wherein the first carrier is provided with a cavity, and the second carrier is arranged at a bottom of the cavity by a plurality of guiding members.

4. The voice coil motor according to claim 3, wherein a plurality of guiding blocks protrude from the bottom of the cavity and extend along a direction toward the second carrier, a bottom of the second carrier is depressed to form a plurality of guiding grooves, the plurality of guiding grooves correspond to the plurality of the guiding blocks, each of the guiding blocks extends into a corresponding guiding groove and forms a guiding cavity, each guiding cavity is accommodating with a corresponding guiding member, each of the guiding members is in contact with a bottom surface of the guiding groove and is capable of moving in the guiding cavity, and a side wall of the guiding cavity is configured for limiting a movement stroke of the corresponding guiding member; or
a plurality of guiding blocks protrude from a bottom of the second carrier and extend along a direction toward the first carrier, the bottom of the cavity is depressed to form a plurality of guiding grooves, the plurality of guiding grooves correspond to the plurality of the guiding blocks, each of the guiding blocks extends into a corresponding guiding groove and forms a guiding cavity, each guiding cavity is accommodating with a corresponding guiding member, each of the guiding members is in contact with a bottom surface of the guiding groove and is capable of moving in the guiding cavity, and a side wall of the guiding cavity is configured for limiting a movement stroke of the corresponding guiding member.

5. The voice coil motor according to claim 1, wherein the housing comprises a base and an outer housing, the outer housing is installed on the base and covers the base, and the focusing structure is accommodated in the base; the first driving assembly comprises a first magnet and a first coil, one of the first magnet and the first coil is arranged on a side wall of the base, another one of the first magnet and the first coil is arranged on a side wall of the first carrier, the first coil is capable of generating a first driving force with the first magnet when powered on, and the first driving force is configured to drive the first carrier to move along the optical axis for focusing.

6. The voice coil motor according to claim 5, wherein an inner side of the side wall of the base is arranged with a guiding element, an outer side of the side wall of the first carrier is arranged with a matching element, and the guiding element cooperates with the matching element to guide the first carrier to move along the optical axis.

7. The voice coil motor according to claim 1, wherein the housing comprises a base and an outer housing, and the outer housing is installed on the base and covers the base; the second driving assembly comprises a second magnet and a second coil, one of the second magnet and the second coil is arranged on a side wall of the base, another one of the second magnet and the second coil is arranged on a side wall of the second sub-section, the second coil is capable of generating a second driving force with the second magnet when powered on, and the second driving force is configured to drive the second carrier to move in the plane perpendicular to the optical axis or to rotate around the optical axis for anti-shaking.

8. The voice coil motor according to claim 1, further comprising:
a fixing structure, installed on the first carrier and configured to limit the second carrier so that the second carrier moves with the first carrier along the optical axis toward an object side of the lens.

9. The voice coil motor according to claim 8, wherein an outer side of a side wall of the first carrier is arranged with a plurality of coupling members; the fixing structure comprises:
a blocking member, arranged on a top of the first carrier and defined with a through hole corresponding to the lens of the second carrier; and
a plurality of connecting members, corresponding to the plurality of coupling members and extending from the blocking member, wherein each of the connecting members is connected to a corresponding coupling member.

10. A camera module, comprising:
a voice coil motor, comprising:
a housing;
a focusing structure, arranged on the housing and comprising a first carrier and a first driving assembly; and
an anti-shake structure, comprising a second carrier and a second driving assembly, wherein the second carrier is an integral structure accommodated in the first carrier and comprises a first sub-section and a second sub-section connected with each other, the first sub-section is configured to accommodate a lens, and the second sub-section is configured to install a partial structure of the second driving assembly;
wherein the first driving assembly is configured to drive the first carrier to move along an optical axis of the lens for focusing, and the second driving assembly is configured to drive the second carrier to move in a plane perpendicular to the optical axis or to rotate around the optical axis for anti-shaking; and
the lens, installed on the first sub-section.

11. The camera module according to claim 10, wherein the second carrier is an integrally injection-molded member.

12. The camera module according to claim 10, wherein the first carrier is provided with a cavity, and the second carrier is arranged at a bottom of the cavity by a plurality of guiding members.

13. The camera module according to claim 12, wherein a plurality of guiding blocks protrude from the bottom of the cavity and extend along a direction toward the second carrier, a bottom of the second carrier is depressed to form a plurality of guiding grooves, the plurality of guiding grooves correspond to the plurality of the guiding blocks, each of the guiding blocks extends into a corresponding guiding groove and forms a guiding cavity, each guiding cavity is accommodating with a corresponding guiding member, each of the guiding members is in contact with a bottom surface of the guiding groove and is capable of moving in the guiding cavity, and a side wall of the guiding cavity is configured for limiting a movement stroke of the corresponding guiding member; or
a plurality of guiding blocks protrude from a bottom of the second carrier and extend along a direction toward the first carrier, the bottom of the cavity is depressed to form a plurality of guiding grooves, the plurality of guiding grooves correspond to the plurality of the guiding blocks, each of the guiding blocks extends into a corresponding guiding groove and forms a guiding cavity, each guiding cavity is accommodating with a corresponding guiding member, each of the guiding members is in contact with a bottom surface of the guiding groove and is capable of moving in the guiding cavity, and a side wall of the guiding cavity is configured for limiting a movement stroke of the corresponding guiding member.

14. The camera module according to claim 10, wherein the housing comprises a base and an outer housing, the outer housing is installed on the base and covers the base, and the focusing structure is accommodated in the base; the first driving assembly comprises a first magnet and a first coil, one of the first magnet and the first coil is arranged on a side wall of the base, another one of the first magnet and the first coil is arranged on a side wall of the first carrier, the first coil is capable of generating a first driving force with the first magnet when powered on, and the first driving force is configured to drive the first carrier to move along the optical axis for focusing.

15. The camera module according to claim 14, wherein an inner side of the side wall of the base is arranged with a guiding element, an outer side of the side wall of the first carrier is arranged with a matching element, and the guiding element cooperates with the matching element to guide the first carrier to move along the optical axis.

16. The camera module according to claim 10, wherein the housing comprises a base and an outer housing, and the outer housing is installed on the base and covers the base; the second driving assembly comprises a second magnet and a second coil, one of the second magnet and the second coil is arranged on a side wall of the base, another one of the second magnet and the second coil is arranged on a side wall of the second sub-section, the second coil is capable of generating a second driving force with the second magnet when powered on, and the second driving force is configured to drive the second carrier to move in the plane perpendicular to the optical axis or to rotate around the optical axis for anti-shaking.

17. The camera module according to claim 10, wherein the voice coil motor further comprises:
a fixing structure, installed on the first carrier and configured to limit the second carrier so that the second carrier moves with the first carrier along the optical axis toward an object side of the lens.

18. The camera module according to claim 17, wherein an outer side of a side wall of the first carrier is arranged with a plurality of coupling members; the fixing structure comprises:
a blocking member, arranged on a top of the first carrier and defined with a through hole corresponding to the lens of the second carrier; and
a plurality of connecting members, corresponding to the plurality of coupling members and extending from the blocking member, wherein each of the connecting members is connected to a corresponding coupling member.

19. An electronic device, comprising:
a main body; and
a camera module, comprising:
a voice coil motor, comprising:
a housing;
a focusing structure, arranged on the housing and comprising a first carrier and a first driving assembly; and
an anti-shake structure, comprising a second carrier and a second driving assembly, wherein the second carrier is an integral structure accommodated in the first carrier and comprises a first sub-section and a second sub-section connected with each other, the first sub-section is configured to accommodate a lens, and the second sub-section is configured to install a partial structure of the second driving assembly;
wherein the first driving assembly is configured to drive the first carrier to move along an optical axis of the lens for focusing, and the second driving assembly is configured to drive the second carrier to move in a plane perpendicular to the optical axis or to rotate around the optical axis for anti-shaking; and
the lens, installed on the first sub-section;
wherein the camera module is installed on the main body.

20. The electronic device according to claim 19, wherein the second carrier is an integrally injection-molded member.
